(19) United States
(12) Patent Application Publication
(10) Pub. No.: US 2026/0361490 A1
(43) Pub. Date: Nov. 12, 2026

(54) MTRP FREQUENCY DRIFT COMPENSATION FOR COHERENT JOINT TRANSMISSION

(71) Applicant: QUALCOMM Incorporated, San Diego, CA (US)

(72) Inventors: Faris RASSAM, El Cajon, CA (US); Jae Ho RYU, San Diego, CA (US); Jing DAI, Beijing (CN); Mostafa KHOSHNEVISAN, San Diego, CA (US); Lei XIAO, San Jose, CA (US)

(21) Appl. No.: 19/127,983

(22) PCT Filed: Dec. 13, 2022
(86) PCT No.: PCT/CN2022/138583

§ 371 Date: May 7, 2025

(51) Int. Cl. H04L 5/00; H04B 7/024; H04B 7/06; H04B 17/309; H04B 17/318; H04W 72/231

(52) U.S. Cl. CPC H04L 5/0051; H04B 7/024; H04B 7/0626; H04B 7/0639; H04B 17/328; H04B 17/346; H04W 72/231

(57) ABSTRACT

A method for wireless communication at a user equipment (UE) and related apparatus are provided. In the method, the UE receives one or more Tracking Reference Signals (TRSs) for multiple Transmit Reception Points (TRPs) of the network entity, and measures frequency drift information, which includes frequency drifts of the one or more TR Ss relative to a reference TRS at the UE. The UE further transmits the frequency drift information to the network entity, and communicates with the network entity based on the frequency drift information.

### TECHNICAL FIELD

The present disclosure relates generally to communication systems, and more particularly, to multiple transmission reception points (mTRP) frequency drift compensation for coherent joint transmission (CJT).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to receive, from a network entity, one or more Tracking Reference Signals (TR Ss) for multiple Transmit Reception Points (TRPs) of the network entity; measure frequency drift information including a frequency drift of the one or more TRSs relative to a reference TRS at the UE; transmit, to the network entity, the frequency drift information; and communicate, based on the frequency drift information, with the network entity.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit, to a UE, one or more TR Ss for multiple TRPs of the network entity; receive, from the UE, frequency drift information including a frequency drift of the one or more TRSs relative to a reference TRS at the UE; and communicate, based on the frequency drift information, with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a diagram illustrating example co-located TRPs.

FIG. 4B is a diagram illustrating example distributed TRPs.

FIG. 5A is a diagram illustrating non-coherent joint transmission (NCJT) with separately pre-coded data on different TRPs.

FIG. 5B is a diagram illustrating coherent joint transmission (CJT) with jointly pre-coded data on different TRPs.

FIG. 6 is a call flow diagram illustrating a method of wireless communication in accordance with various aspects of the present disclosure.

FIG. 7 is the first flowchart illustrating methods of wireless communication at a UE in accordance with various aspects of the present disclosure.

FIG. 8 is the second flowchart illustrating methods of wireless communication at a UE in accordance with various aspects of the present disclosure.

FIG. 9 is the first flowchart illustrating methods of wireless communication at a network entity in accordance with various aspects of the present disclosure.

FIG. 10 is the second flowchart illustrating methods of wireless communication at a network entity in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Various aspects relate generally to wireless communication. Some aspects more specifically relate to mTRP frequency drift compensation for CJT. In some examples, a UE may receive, from a network entity, one or more TR Ss for multiple TRPs of the network entity; measure frequency drift information including a frequency drift of the one or more TRSs relative to a reference TRS at the UE; transmit, to the network entity, the frequency drift information; and communicate, based on the frequency drift information, with the network entity. In some examples, a network entity may transmit, to a UE, one or more TR Ss for multiple TRPs of the network entity; receive, from the UE, frequency drift information including a frequency drift of the one or more TRSs relative to a reference TRS at the UE; and communicate, based on the frequency drift information, with the UE.

Particular aspects of the subject matter described in this disclosure can be implemented to realize one or more of the following potential advantages. In some examples, by transmitting one or more TRSs to the UE, the described techniques enable the UE or the base station to monitor and compensate for the frequency drift of one or multiple TRPs of the base station or base stations. The described techniques further allow the UE or the base station to select a transmission mode for improved performance based on the frequency drift, and to reuse transmission parameters, such as the precoder, computed at an earlier time for the current communication. Thus, the method improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

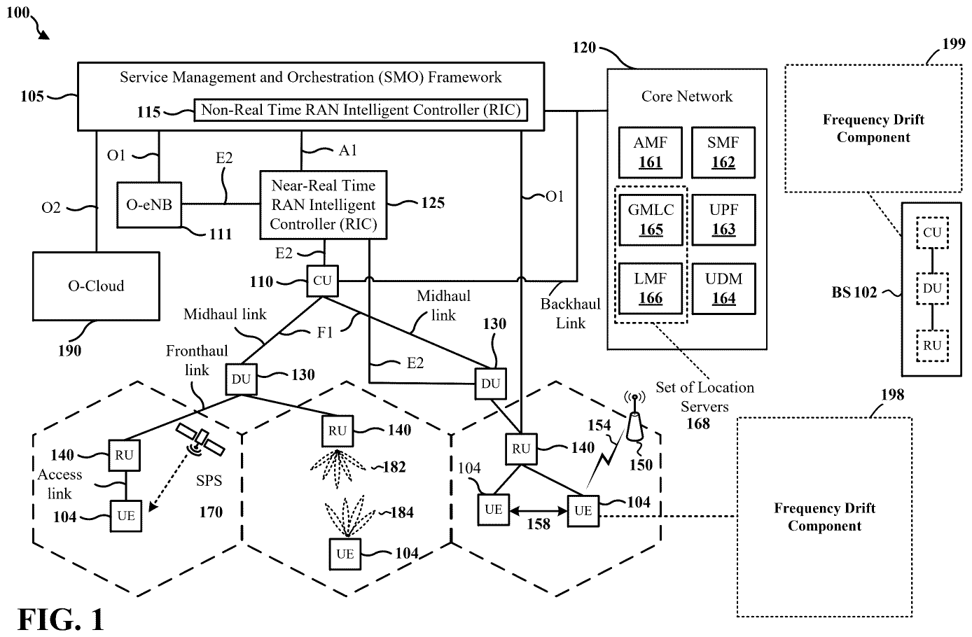

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRA CH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR 1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR 1 and FR 2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR 1 and/or FR 2 into mid-band frequencies. In addition, higher frequency bands are currently being explored to extend 5G NR operation beyond 52.6 GHz. For example, three higher operating bands have been identified as frequency range designations FR 2-2 (52.6 GHz-71 GHz), FR 4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR 1, or may include mid-band frequencies. Further, unless specifically stated otherwise, the term “millimeter wave” or the like if used herein may broadly represent frequencies that may include mid-band frequencies, may be within FR2, FR4, FR 2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NRE-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a frequency drift component 198. The frequency drift component 198 may be configured to receive, from a network entity, one or more TRSs for multiple TRPs of the network entity; measure frequency drift information including a frequency drift of the one or more TR Ss relative to a reference TRS at the UE; transmit, to the network entity, the frequency drift information; and communicate, based on the frequency drift information, with the network entity. In certain aspects, the base station 102 may include a frequency drift component 199. The frequency drift component 199 may be configured to transmit, to a UE, one or more TR Ss for multiple TRPs of the network entity; receive, from the UE, frequency drift information including a frequency drift of the one or more TRSs relative to a reference TRS at the UE; and communicate, based on the frequency drift information, with the UE. Although the following description may be focused on 5G NR, the concepts described herein may be applicable to other similar areas, such as LTE, LTE-A, CDMA, GSM, and other wireless technologies.

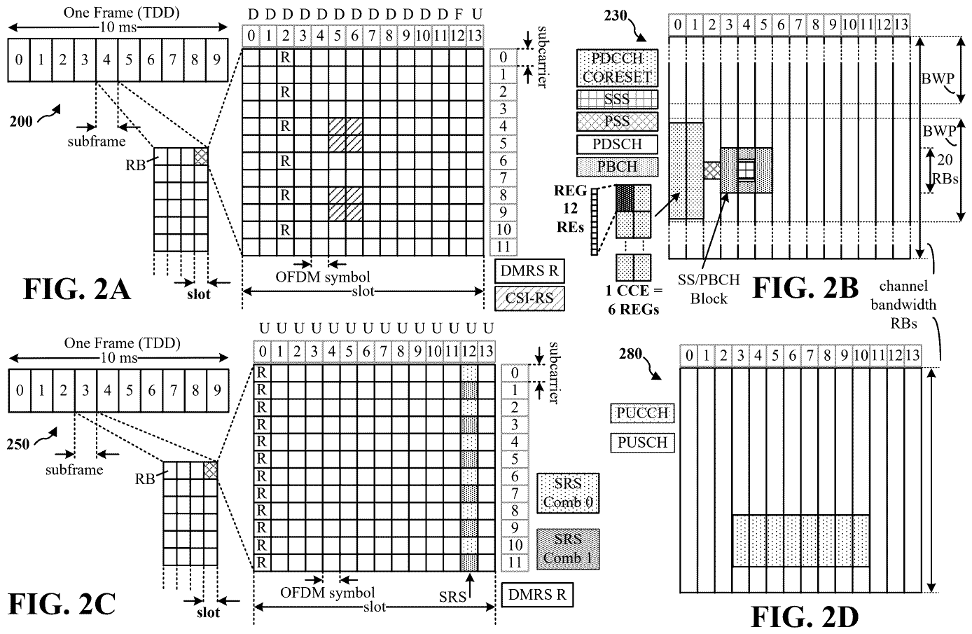

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PB CH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number. The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

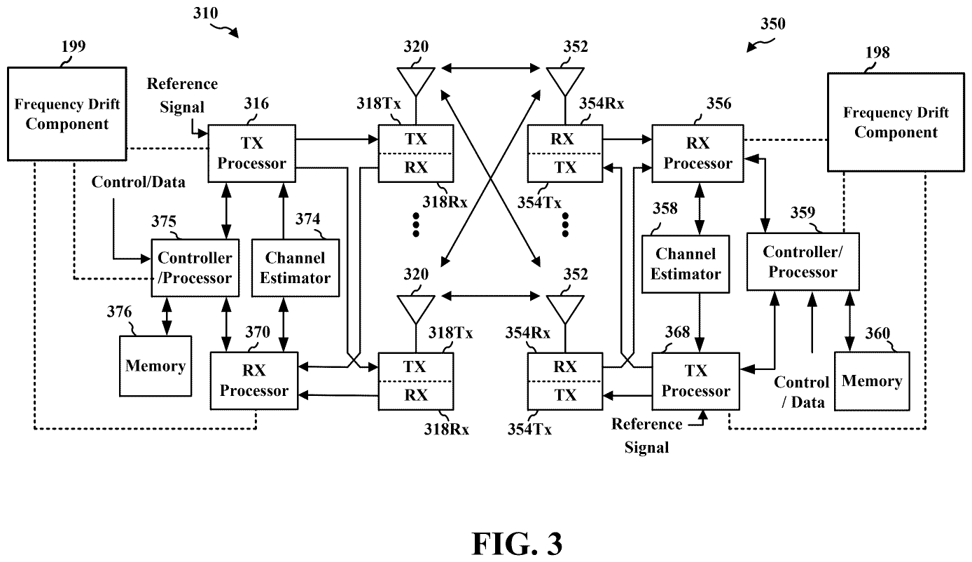

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the frequency drift component 198 of FIG. 1.

At least one of the TX processor 316, the RX processor 370, and the controller/processor 375 may be configured to perform aspects in connection with the frequency drift component 199 of FIG. 1.

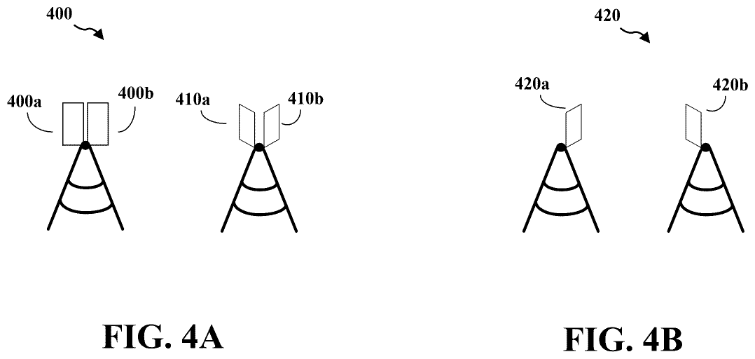

A wireless device may include multiple TRPs (mTRP). Each TRP may include different RF modules having a shared hardware and/or software controller. Each TRP may have separate RF and digital processing. Each TRP may also perform separate baseband processing. Each TRP may include a different antenna panel or a different set of antenna elements of a wireless device. In some applications, the TRPs of the wireless device may be located at the same physical location (i.e., co-located TRPs), and each of the co-located TRPs may have the same boresight orientation or different boresight orientations. FIG. 4A is a diagram 400 illustrating example co-located TRPs. As shown in FIG. 4A, the TRP 400a and TRP 400b are two co-located TRPs that have the same boresight orientation, while TRP 410a and TRP 410b are two co-located TRPs that have different boresight orientations.

In some other applications, the TRPs of the wireless device may be physically separated (i.e., distributed TRPs). For example, TRPs on a wireless device may be located at separated locations, such as separated signal towers. Each of the TRPs may experience a channel differently (e.g., experience a different channel quality) due to different physical locations, the distance between the TRPs, different line-of-sight (LOS) characteristics (e.g., a LOS channel in comparison to a non-LOS (NLOS) channel), blocking/obstructions, interference from other transmissions, among other reasons. FIG. 4B is a diagram 420 illustrating example distributed TRPs. As shown in FIG. 4B, TRP 420a and TRP 420b are two distributed TRPs.

Wireless communication with multiple TRPs may transmit a signal through non-coherent joint transmission (NCJT) or coherent joint transmission (CJT). In NCJT, data may be pre-coded separately by the corresponding precoders on different TRPs. In one example, the precoding of the data may be described as:

$$[ \begin{matrix}{W}_{A} & 0 \\ 0 & {W}_{B}\end{matrix} ] [ \begin{matrix}{X}_{A} \\ {X}_{B}\end{matrix} ] = [ \begin{matrix}{W}_{A} {X}_{A} \\ {W}_{B} {X}_{B}\end{matrix} ] \qquad ( 1 )$$

where the subscripts A and B represent different TRPs, the precoders (W_{A}, W_{B}) may each have a size of

$$( {N}_{t}^{TRP} \times {RI}^{TRP} ) , where {N}_{t}^{TRP}$$

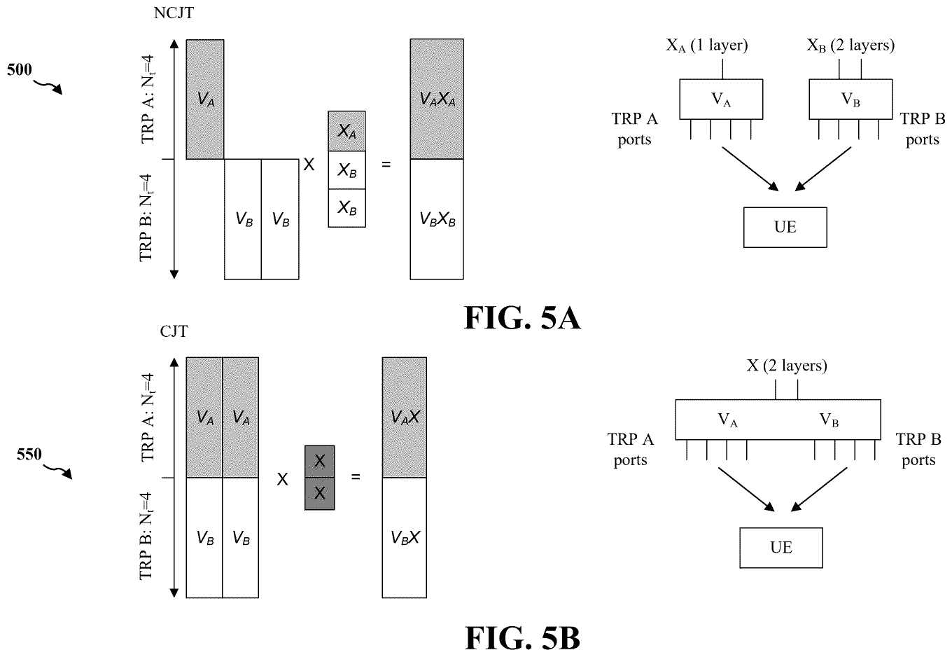

is the number of ports for this TRP, RI^{TRP} is the rank indication for this TRP, and the data (X_{A}, X_{B}) may each have a size of (RI^{TRP}×1). FIG. 5A is a diagram 500 illustrating NCJT with separately pre-coded data on different TRPs. In the example of FIG. 5A,

$${N}_{t}^{TRP}$$

and RI^{TRP} for the first TRP (e.g., TRP A) and the second TRP (e.g., TRP B) have the size of:

$${N}_{t}^{A} = 4 , {RI}^{A} = 1 , {N}_{t}^{B} = 4 , and {RI}^{B} = 2.$$

Hence, the precoders have the size of: W_{A}: 4×1; W_{B}: 4×2, and the data has the size of: X_{A}: 1×1, X_{B}: 2×1.

In CJT, data may be pre-coded jointly for different TRPs. In one example, the precoding of the data may be described as:

$$[ \begin{matrix}{W}_{A} \\ {W}_{B}\end{matrix} ] X = [ \begin{matrix}{W}_{A} X \\ {W}_{B} X\end{matrix} ] \qquad ( 2 )$$

where the subscripts A and B represent different TRPs, the precoders (W_{A}, W_{B}) may each have a size of

$$( {N}_{t}^{TRP} \times {RI}^{CJT} ) , where {N}_{t}^{TRP}$$

is the number of ports for this TRP, RI^{CJT} is the rank jointly obtained from all the TRPs, and X is data and may have the size of (RI^{CJT}×1). FIG. 5B is a diagram 550 illustrating CJT with jointly pre-coded data on different TRPs. In the example of FIG. 5B,

$${N}_{t}^{TRP}$$

for the first TRP (TRPA) and the second TRP (TRPB) have the size of:

$${N}_{t}^{A} = 4 , and {N}_{t}^{B} = 4 , and {RI}^{CJT} = 2.$$

Hence, the precoders have the size of: W_{A}: 4×2; W_{A}: 4×2, and the data has the size of: X: 2×1.

The precoding scheme for the mTRP CJT operation, such as that described in Equation (2), does not consider the phase alignment error between the TRPs (i.e., it assumes ideal synchronization between the TRPs). However, the synchronization error due to, for example, the oscillator drift may be a key issue for practical commercial applications of CJT mTRP.

It is more practical for the co-located TRPs (with the same or different boresight orientation) to achieve the ideal synchronization than the distributed TRPs. For example, the co-located TRPs may share the same local oscillator (LO) and thus have ideal synchronization. On the other hand, for a cost-practical deployment of distributed TRPs, each of the distributed TRPs may have its individual LO. In one example, the oscillator drift across different distributed TRPs may be in a range of 0.05 to 0.1 pulse position modulation (ppm). Thus, even within a short period of only 10 msec, the maximum phase error may reach 126° (2π(700×10⁶)×(0.05×10⁻⁶)× (10×10⁻³)=126°), assuming a low band of 700 mHz carrier. The phase error may be even larger with a higher carrier frequency. For the distributed TRPs, the ideal synchronization may be difficult to be satisfied even with an ideal backhaul.

The phase variation (or phase drift) across the TRPs may affect the signal-noise-ratio (SNR) of an mTRP CJT operation. The data transmission of an mTRP CJT operation may be described as:

$$Y = [ \begin{matrix}{H}_{A} & {H}_{B}\end{matrix} ] [ \begin{matrix}{W}_{A} \\ {W}_{B}\end{matrix} ] X + N = ( {H}_{A} {W}_{A} + {H}_{B} {W}_{B} ) X + N \qquad ( 3 )$$

where Y is the received transmission signal, H_{A} and H_{B} are Rx-Tx channel responses for TRP A and TRP B, respectively. W_{A} and We are the precoder for TRP A and TRP B, respectively. X is the data symbol to be transmitted, and N is the noise.

Assuming the receiver is a linear minimum mean square error (LMMSE) receiver, the SNR may be described as:

SNR_{X}_{₁}=(H_{A}W_{A}+H_{B}W_{B})^{H}(Σ_{N})⁻¹(H_{A}W_{A}+H_{B}W_{B}) (4)

where the superscript H represents the Hermitian transpose, Σ_{N} is the noise covariance NN^{H}. According to Equation (4), the introduction of a phase difference between H_{A} and H_{B} may impact the LMMSE SNR. The presence of frequency error with respect to the reference TRS/TRP may result in time-varying phase differences between the TRPs. The best precoder computed at time t₁ will be different from the best precoder computed at time t₂ in the presence of the frequency error.

There are several schemes to mitigate or alleviate the issues caused by the frequency drift between the TRPs.

In one scheme, the TRPs may guarantee, or have, an ideal frequency alignment without LO drift, or with LO drift below a threshold, with time. The UE may compute PMI feedback without the frequency compensation. This scheme may work for co-located TRPs but may be less feasible for distributed TRPs.

In another scheme, the TRPs may configure a frequency drift report. The frequency drift reports from multiple UEs may be used to align the frequency errors with respect to the reference TRS or reference TRP (e.g., which may be referred to as a reference TRS/TRP). To enable the frequency drift reports, a TRS resource evaluation may be performed for each TRP. The TRPs may apply frequency correction based on the frequency drift reports from the UEs. A UE may measure CSI reports based on readily compensated CSI-RS transmissions. In this scheme, the frequency corrections may be more accurate to provide the minimal phase drift between TRPs, as a small frequency drift may result in large gain losses and precoder variability. Doppler shift frequency variations between UEs may introduce additional errors in feedback to TRPs that may be filtered. Thus, TRS resource optimization may be introduced to handle higher frequency deviations, especially for FR2.

In yet another scheme, the TRPs may transmit non-frequency compensated CSI-RS, and the UE may measure and compensate for frequency drift between TRPs when CSI-RS measurements are made based on TRS measurements with respect to the reference TRS/TRP. The UE may also provide feedback on the frequency drift between TRPs. In this scheme, a TRS resource evaluation may be performed for each TRP. The TRPs may use the CSI feedback from the UEs and the frequency drift measurement to decide whether to use CJT transmission or to switch to a different mode of mTRP transmission (e.g., NCJT) or non-mTRP transmission (e.g., single TRP transmission). The TRPs may also compute a new precoder at the time of precoder application.

Aspects of the present disclosure are directed to methods and apparatus for mTRP frequency drift compensation for CJT.

One aspect of the present disclosure is directed to inter-TRP frequency drift reporting. To assist the frequency synchronization among multiple TRPs, a UE may measure and report the inter-TRP frequency drift. The base station may configure TRS resources for each TRP along with an indication for a reference TRS. In one configuration, one TRS may be transmitted for each TRP. In another configuration, the TRS may be transmitted on a single frequency network (SFN) manner for a group of ideally synchronized TRPs. The UE may measure and track the frequency error for each TRS and report inter-TRS frequency drift relative to the reference TRS. Additionally, the UE may provide a quality metric (e.g., standard deviation, SNR) of the inter-TRS frequency drift. The base station may determine the inter-TRS frequency error based on the frequency drift report from the UE. In one configuration, the base station may receive the frequency drift reports from multiple UEs and determine the inter-TRS frequency error by averaging the frequency drift reports from the multiple UEs. The base station may additionally apply different weights when averaging the inter-TRP frequency drifts based on the reported quality metrics. For example, when averaging the frequency drift reports, the base station may assign a higher weight for a UE that reports a better quality metric. The inter-TRP frequency drift reporting and compensation may be applicable to both SRS-based and CSI feedback-based CJT precoding applications.

In one configuration, based on the inter-TRS frequency error, the base station may dynamically switch between CJT CSI reporting and NCJT CSI reporting. For example, based on the quality of the averaged inter-TRS frequency drift, the base station may determine whether CJT CSI or NCJT CSI is to be reported by the UE. For the aperiodic CSI (A-CSI) reporting, the base station may dynamically indicate CJT CSI reporting or NCJT CSI reporting. In one example, an explicit bit field in UL DCI may be used to trigger the A-CSI reporting. In another example, the base station may configure separate CSI trigger states for CJT CSI reporting and NCJT CSI reporting.

In one configuration, based on the inter-TRS frequency error, the UE may autonomously switch between CJT CSI reporting or NCJT CSI reporting. For example, based on inter-TRS frequency error measurement, a UE may determine whether CJT CSI or NCJT CSI is to be used to provide better DL performance. In one example, a UE may provide CSI feedback for a preferred mode between the CJT precoding, the NCJT precoding, or the single TRP precoding.

Another aspect of the present disclosure is directed to inter-TRP frequency compensation for DM-RS and PDSCH precoding. In some aspects, each TRP selected for the mTRP operation may transmit per-TRP TRS and CSI-RS without any frequency compensation. When a group of TRPs are synchronized (e.g., driven by a common LO), the TRS can be transmitted in an SFN manner for the group of TRPs. Based on the UE's PMI feedback and inter-TRP frequency drift measurement at time t, the base station may compensate for the frequency drift to determine DM-RS and PDSCH precoding at time t+ΔT. For example, let H_{A} (t+Δt) and H_{B} (t+Δt) be the channel responses of TRP A and TRP B, respectively, at time t+ΔT, and fₑ be the frequency drift of TRP B that was measured by the UE and reported to the base station. The DL transmission Y the UE received may be described as:

$$Y = [ \begin{matrix}{H}_{A} ( t + Δ t ) & {e}^{- j 2 π {f}_{e} Δ t} {H}_{B} ( t + Δ t )\end{matrix} ] [ \begin{matrix}{W}_{A} \\ {W}_{B}\end{matrix} ] X + N \qquad ( 5 )$$

where W_{A} and W_{B} are the precoders used as reported by the UE at time t for TRP A and TRP B, respectively, and e^{-j2πf}^{ₑ}^{Δt} is the frequency compensation the base station applied to the transmission from TRP B. As shown in Equation (5), after the frequency compensation, the precoders at time t (i.e., W_{A} and W_{B}) may be reused for the transmission at another time (e.g., time t+Δt).

From the UE's perspective, the UE may measure/track the inter-TRP frequency drift based on the per-TRP TRS measurement. In one configuration, one TRS may be transmitted for each TRP. In another configuration, the TRS may be transmitted on a single frequency network (SFN) manner for a group of synchronized TRPs. Additionally, the UE may measure CSI (e.g., RI, PMI, CQI, Layer Indicator (LI)) for CJT based on CSI-RS measurement from multiple TRPs at a slot (e.g., slot n). The UE may report the frequency drift and CSI reference time t along with CSI feedback. The UE may report the PMI assuming the frequency correction has been applied between the TRPs. If the base station performed the frequency compensation, the PMI the UE measured at slot n will still be applicable after time Δt.

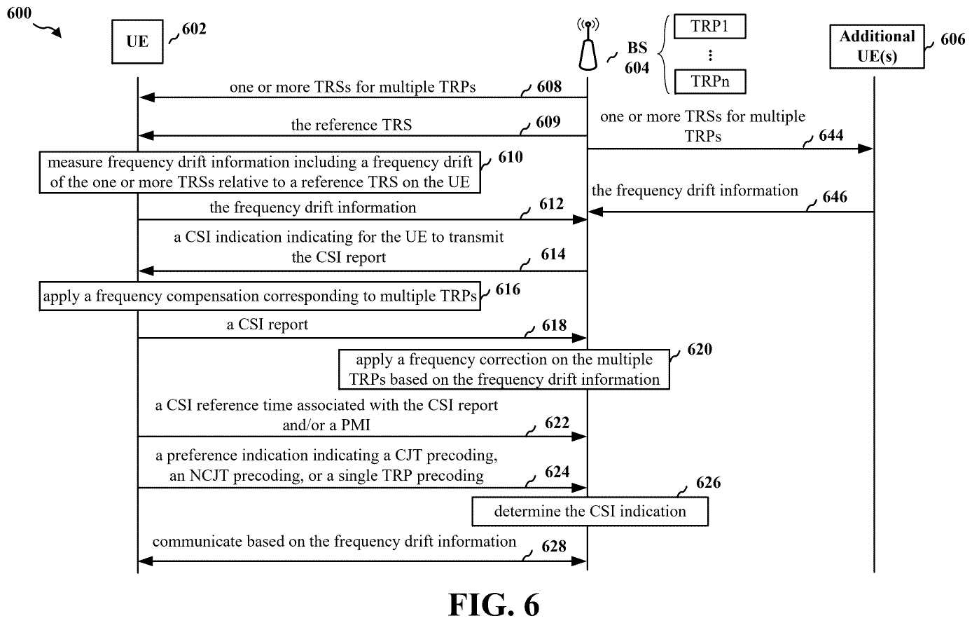

FIG. 6 is a call flow diagram 600 illustrating a method of wireless communication in accordance with various aspects of this present disclosure. Although aspects are described for a base station 604, the aspects may be performed by a base station in aggregation and/or by one or more components of a base station 604 (e.g., such as a CU 110, a DU 130, and/or an RU 140). As illustrated, the base station 604 may be associated with or include multiple TRPs (TRP1 . . . TRPn). The multiple TRPs may include aspects described in connection with, for example, FIGS. 5A, 5B.

As shown in FIG. 6, at 608, the base station 604 may transmit one or more TR Ss for multiple TRPs of the base station 604 to the UE 602. In one example, one TRS may be transmitted for each TRP. In another example, one TRS may be transmitted on the SFN manner for a group of ideally synchronized TRPs.

At 610, the UE 602 may measure frequency drift information. The frequency drift information may include the frequency drift of the one or more TRSs relative to a reference TRS at the UE. The UE 602 may receive the reference TRS from the base station 604, for example, at 609.

At 612, the UE 602 may transmit the frequency drift information to the base station 604. The frequency drift information frequency drift information may include a frequency drift of the one or more TRSs relative to a reference TRS. In some examples, the frequency drift information may further include a quality metric of the frequency drift. The quality metric may include one or more of: the standard deviation of the frequency drift, the SNR of the frequency drift, the reference signal received power (RSRP); and the reference signal received quality (RSRQ).

At 614, the base station 604 may transmit to the UE 602 a CSI indication indicating for the UE to transmit the CSI report.

At 616, the UE 602 may apply a frequency compensation corresponding to multiple TRPs. The frequency compensation may be made when the CSI report is made.

At 618, the UE 602 may transmit a CSI report to the base station 604. The CSI report may indicate a preferred transmission mode with the base station 604. For example, the CSI report may indicate one of CJT with the multiple TRPs, NCJT with the multiple TRPs, or a transmission with a single TRP of the multiple TRPs.

At 620, the base station 604 may apply a frequency correction on the multiple TRPs based on the frequency drift information.

At 622, the UE 602 may transmit to the base station 604 at least one of a CSI reference time associated with the CSI report and/or a PMI. The PMI may be based on the frequency drift information.

At 624, the UE 602 may transmit to the base station 604 a preference indication. The preference indication may indicate a CJT precoding, an NCJT precoding, or a single TRP precoding.

At 626, the base station 604 may determine the CSI indication. The CSI indication may be determined based on the frequency drift information the base station 604 received from the UE 602 at, for example, 612.

In some aspects, the base station 604 may be connected with one or more additional UE(s) 606. In that case, at 644, the base station 604 may transmit one or more TRSs for multiple TRPs to the additional UE(s) 606. At 646, the base station 604 may receive the corresponding frequency drift information (e.g., the frequency drift relative to the reference TRS and/or the quality metric of the frequency drift) from each of the additional UE(s) 606.

When the base station 604 are connected to multiple UEs (e.g., 602 and 606), the base station may, at 626, determine the CSI indication based on the frequency drift information received from the multiple UEs (e.g., the frequency drift information received at 612 and at 646).

At 628, the UE 602 and the base station 604 may communicate based on the frequency drift information.

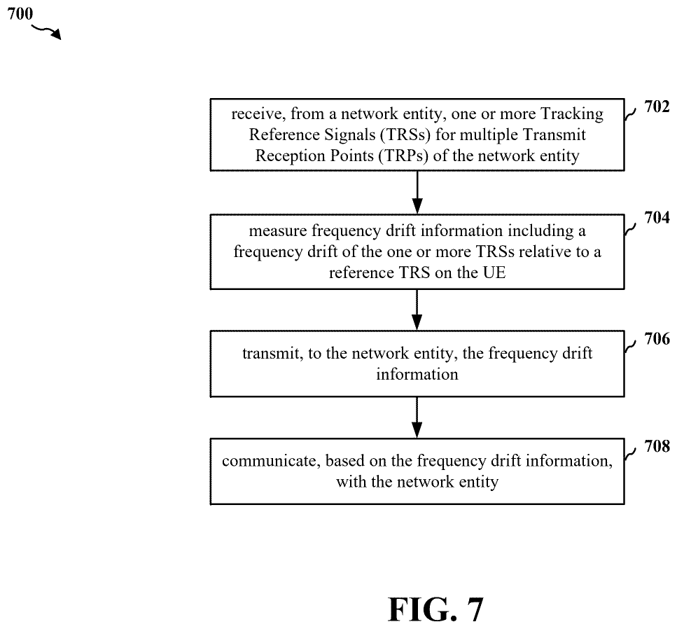

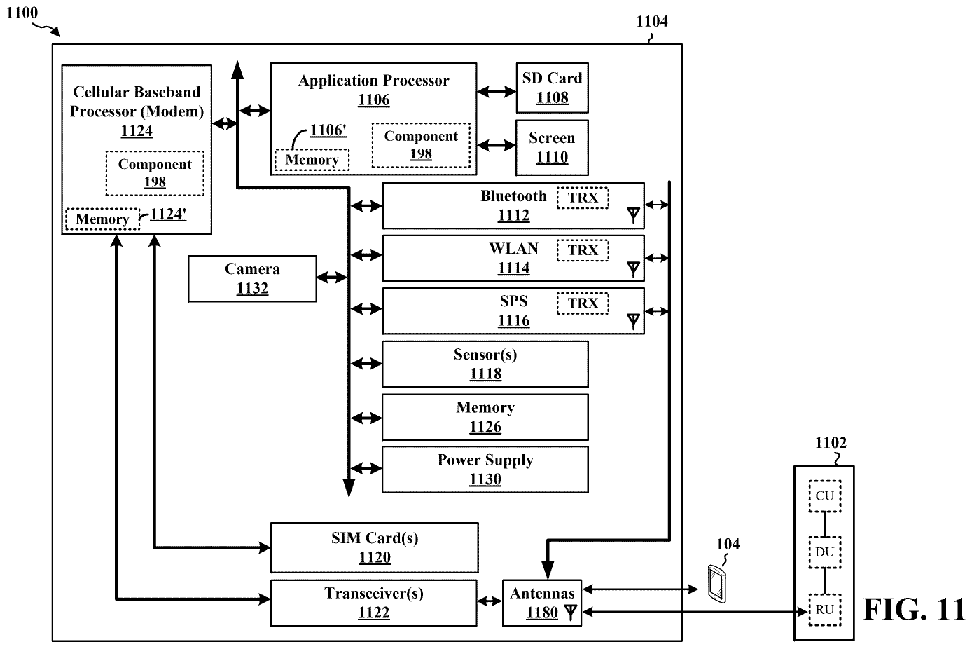

FIG. 7 is a flowchart 700 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method enables a UE or a base station to monitor and compensate for the frequency drift of one or multiple TRPs of the base station or base stations. The frequency drift information further allows the UE or the base station to select a transmission mode for improved performance, e.g., which may be referred to as an optimal transmission mode, and to reuse transmission parameters, such as the precoder, computed at an earlier time for the current communication. Thus, the method improves the efficiency of wireless communication.

As shown in FIG. 7, at 702, the UE may receive, from a network entity, one or more TRSs for multiple TRPs of the network entity. The network entity may be a base station, or a component of a base station, in the access network of FIG. 1 or a core network component (e.g., base station 102, 310, 604; or the network entity 1102 in the hardware implementation of FIG. 11). FIG. 6 illustrates various aspects of the steps in connection with flowchart 700. For example, referring to FIG. 6, the UE 602 may receive, at 608, from a network entity (base station 604), one or more TRSs for multiple TRPs (e.g., TRP1 . . . TRPn for base station 604) of the network entity (base station 604).

At 704, the UE may measure the frequency drift information. The frequency drift information may include a frequency drift of the one or more TRSs relative to a reference TRS at the UE. For example, referring to FIG. 6, the UE 602 may measure, at 610, the frequency drift information. The frequency drift information may include a frequency drift of the one or more TRSs relative to a reference TRS at the UE 602.

At 706, the UE may transmit the frequency drift information to the network entity. For example, referring to FIG. 6, the UE 602 may transmit, at 612, the frequency drift information to the network entity (base station 604).

At 708, the UE may communicate with the network entity based on the frequency drift information. For example, referring to FIG. 6, the UE 602 may communicate, at 628, with the network entity (base station 604) based on the frequency drift information.

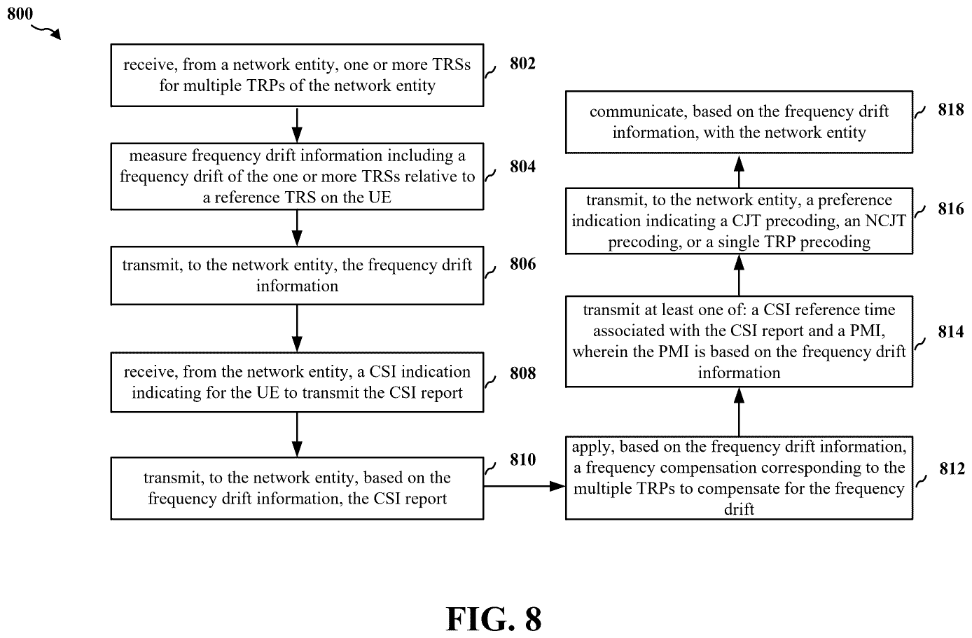

FIG. 8 is a flowchart 800 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method enables a UE or a base station to monitor and compensate for the frequency drift of one or multiple TRPs of the base station or base stations. The frequency drift information further allows the UE or the base station to select a transmission mode for improved performance, and to reuse transmission parameters, such as the precoder, computed at an earlier time for the current communication. Thus, the method improves the efficiency of wireless communication.

As shown in FIG. 8, at 802, the UE may receive, from a network entity, one or more TRSs for multiple TRPs of the network entity. The network entity may be a base station, or a component of a base station, in the access network of FIG. 1 or a core network component (e.g., base station 102, 310, 604; or the network entity 1102 in the hardware implementation of FIG. 11). FIG. 6 illustrates various aspects of the steps in connection with flowchart 800. For example, referring to FIG. 6, the UE 602 may receive, at 608, from a network entity (base station 604), one or more TRSs for multiple TRPs (e.g., TRP1 . . . TRPn for base station 604) of the network entity (base station 604).

At 804, the UE may measure the frequency drift information. The frequency drift information may include a frequency drift of the one or more TRSs relative to a reference TRS at the UE. For example, referring to FIG. 6, the UE 602 may measure, at 610, the frequency drift information. The frequency drift information may include a frequency drift of the one or more TRSs relative to a reference TRS at the UE 602.

At 806, the UE may transmit the frequency drift information to the network entity. For example, referring to FIG. 6, the UE 602 may transmit, at 612, the frequency drift information to the network entity (base station 604).

In some aspects, the frequency drift information may further include one or more of: the standard deviation of the frequency drift, the SNR of the frequency drift, the RSRP, and the RSRQ. For example, referring to FIG. 6, when the UE 602 transmits, at 612, the frequency drift information, the frequency drift information may further include one or more of: the standard deviation of the frequency drift, the SNR of the frequency drift, the RSRP, and the reference signal received quality RSRQ.

As illustrated at 808, the UE may receive a CSI indication from the network entity. The CSI indication may indicate for the UE to transmit the CSI report for one of: the CJT with the multiple TRPs, the NCJT with the multiple TRPs, or the transmission with the single TRP of the multiple TRPs. The CSI report may be transmitted according to the CSI indication. For example, referring to FIG. 6, the UE 602 may receive, at 614, a CSI indication from the network entity (base station 604). The CSI indication may indicate for the UE 602 to transmit the CSI report for one of: the CJT with the multiple TRPs (e.g., TRP1 . . . TRPn of base station 604), the NCJT with the multiple TRPs, or the transmission with the single TRP of the multiple TRPs (e.g., TRP1 . . . TRPn of base station 604). The CSI report (the UE 602 transmitted at 618) may be transmitted according to the CSI indication.

In some aspects, the CSI report may be an aperiodic CSI report. For example, referring to FIG. 6, when the UE 602 transmits, at 618, the CSI report, the CSI report may be an aperiodic CSI report.

In some aspects, the aperiodic CSI report may be triggered by a bit field in DCI. For example, referring to FIG. 6, the aperiodic CSI report (which the UE 602 transmits at 618) may be triggered by a bit field in DCI.

In some aspects, the aperiodic CSI report may include a CJT CSI report and an N CJT CSI report. The CJT CSI report may be triggered by a first CSI state trigger, and the NCJT CSI report may be triggered by a second CSI state trigger different from the first CSI state trigger. For example, referring to FIG. 6, the aperiodic CSI report (which the UE 602 transmits at 618) may include a CJT CSI report and an NCJT CSI report. The CJT CSI report may be triggered by a first CSI state trigger, and the N CJT CSI report may be triggered by a second CSI state trigger different from the first CSI state trigger.

In some aspects, the CSI report may be a periodic CSI report or a semi-persistent CSI report. The CSI indication may be received via a MAC-CE. For example, referring to FIG. 6, when the UE 602 transmits, at 618, the CSI report, the CSI report may be a periodic CSI report or a semi-persistent CSI report. The CSI indication (at 614) may be received via a MAC-CE.

In some aspects, the semi-persistent CSI report may include a CJT CSI report and an NCJT CSI report. The CJT CSI report may be triggered by a first CSI state trigger, and the NCJT CSI report may be triggered by a second CSI state trigger different from the first CSI state trigger. For example, referring to FIG. 6, the semi-persistent CSI report (which the UE 602 transmits at 618) may include a CJT CSI report and an NCJT CSI report. The CJT CSI report may be triggered by a first CSI state trigger, and the NCJT CSI report may be triggered by a second CSI state trigger different from the first CSI state trigger.

At 810, the UE may transmit, based on the frequency drift information, the CSI report to the network entity. The CSI report may be for one of: CJT with the multiple TRPs, NCJT with the multiple TRPs, or a transmission with a single TRP of the multiple TRPs. For example, referring to FIG. 6, the UE 602 may transmit, at 618, based on the frequency drift information, a CSI report to the network entity (base station 604). The CSI report may be for one of: CJT with the multiple TRPs (e.g., TRP1 . . . TRPn of base station 604), NCJT with the multiple TRPs (e.g., TRP1 . . . TRPn of base station 604), or a transmission with a single TRP of the multiple TRPs (e.g., TRP1 . . . TRPn of base station 604).

At 812, the UE may apply, based on the frequency drift information, a frequency compensation corresponding to the multiple TRPs to compensate for the frequency drift. The CSI report may be based on the frequency compensation. For example, referring to FIG. 6, the UE 602 may apply, at 616, based on the frequency drift information (received at 612), a frequency compensation corresponding to the multiple TRPs to compensate for the frequency drift. The CSI report (the UE 602 sends at 618) may be based on the frequency compensation.

At 814, the UE may transmit at least one of a CSI reference time associated with the CSI report and a PMI to the network entity. The PMI may be based on the frequency drift information. For example, referring to FIG. 6, the UE 602 may transmit, at 622, at least one of a CSI reference time associated with the CSI report (sends at 618) and a PMI to the network entity (base station 604). The PMI may be based on the frequency drift information (the UE 602 received at 612).

At 816, the UE may transmit a preference indication indicating a CJT precoding, an NCJT precoding, or a single TRP precoding to the network entity. For example, referring to FIG. 6, the UE 602 may transmit, at 624, a preference indication indicating a CJT precoding, an NCJT precoding, or a single TRP precoding to the network entity (base station 604).

In some aspects, each TRS of the one or more TR Ss respectively may correspond to a single TRP of the multiple TRPs. For example, referring to FIG. 6, each TRS of the one or more TRSs (which the UE 602 received at 608) may respectively correspond to a single TRP of the multiple TRPs (TRP1 . . . TRPn of the base station 604).

In some aspects, one TRS of the multiple TRSs may correspond to a group of synchronized TRPs of the multiple TRPs. For example, referring to FIG. 6, one TRS of the one or more TRSs (which the UE 602 receives at 608) may correspond to a group of synchronized TRP of the multiple TRPs (TRP1 . . . TRPn of the base station 604).

At 818, the UE may communicate with the network entity based on the frequency drift information. For example, referring to FIG. 6, the UE 602 may communicate, at 628, with the network entity (base station 604) based on the frequency drift information.

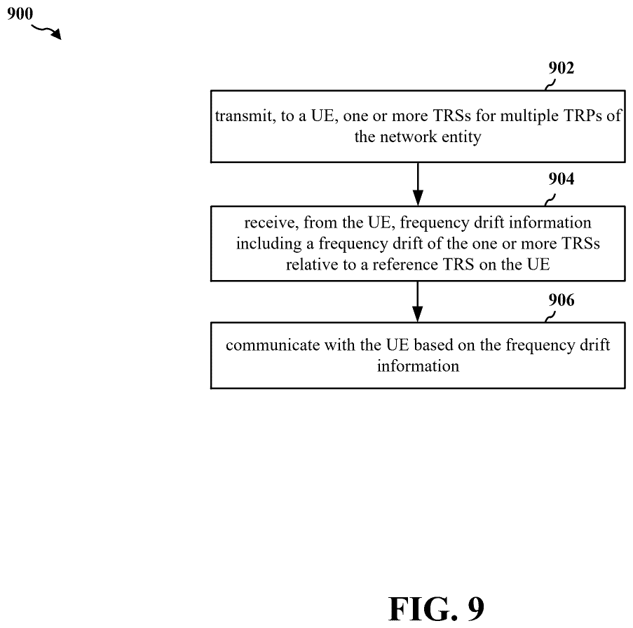

FIG. 9 is a flowchart 900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method enables a UE or a base station to monitor and compensate for the frequency drift of one or multiple TRPs of the base station or base stations. The frequency drift information further allows the UE or the base station to select a transmission mode for improved performance, and to reuse transmission parameters, such as the precoder, computed at an earlier time for the current communication. Thus, the method improves the efficiency of wireless communication.

As shown in FIG. 9, at 902, the network entity may transmit one or more TRSs for multiple TRPs of the network entity to a UE. The UE may be the UE 104, 350, 602, or the apparatus 1104 in the hardware implementation of FIG. 11. FIG. 6 illustrates various aspects of the steps in connection with flowchart 900. For example, referring to FIG. 6, the network entity (base station 604) may transmit, at 608, one or more TRSs for multiple TRPs of the network entity (TRP1 . . . TRPn of the base station 604) to a UE 602.

At 904, the network entity may receive the frequency drift information from the UE. The frequency drift information may include a frequency drift of the one or more TRSs relative to a reference TRS at the UE. For example, referring to FIG. 6, the network entity (base station 604) may receive, at 612, the frequency drift information from the UE 602. The frequency drift information may include a frequency drift of the one or more TRSs relative to a reference TRS (which the UE 602 may receive at 609) on the UE 602.

At 906, the network entity may communicate with the UE based on the frequency drift information. For example, referring to FIG. 6, the network entity (base station 604) may communicate, at 628, with the UE 602 based on the frequency drift information.

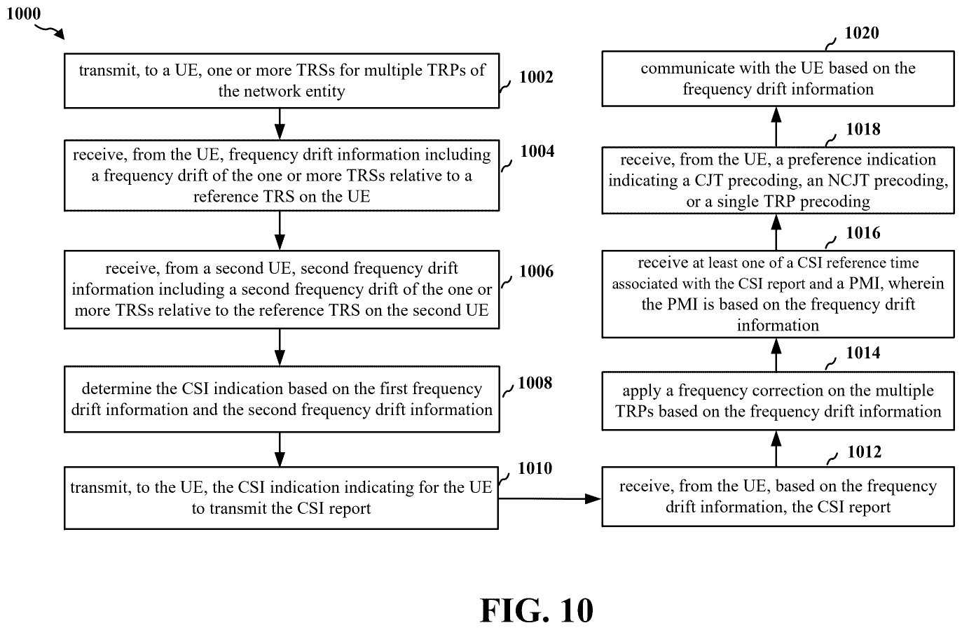

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method enables a UE or a base station to monitor and compensate for the frequency drift of one or multiple TRPs of the base station or base stations. The frequency drift information further allows the UE or the base station to select a transmission mode for improved performance, and to reuse transmission parameters, such as the precoder, computed at an earlier time for the current communication. Thus, the method improves the efficiency of wireless communication.

As shown in FIG. 10, at 1002, the network entity may transmit one or more TRSs for multiple TRPs of the network entity to a UE. The UE may be the UE 104, 350, 602, or the apparatus 1104 in the hardware implementation of FIG. 11. FIG. 6 illustrates various aspects of the steps in connection with flowchart 1000. For example, referring to FIG. 6, the network entity (base station 604) may transmit, at 608, one or more TRSs for multiple TRPs of the network entity (TRP1 . . . TRPn of the base station 604) to a UE 602.

At 1004, the network entity may receive the frequency drift information from the UE. The frequency drift information may include a frequency drift of the one or more TRSs relative to a reference TRS at the UE. For example, referring to FIG. 6, the network entity (base station 604) may receive, at 612, the frequency drift information from the UE 602. The frequency drift information may include a frequency drift of the one or more TRSs relative to a reference TRS (which the UE 602 may receive at 609) on the UE 602.

In some aspects, the frequency drift information may further include one or more of: the standard deviation of the frequency drift, the SNR of the frequency drift, the RSRP, or the RSRQ. For example, referring to FIG. 6, when the base station 604 receives, at 612, the frequency drift information, the frequency drift information may further include one or more of: the standard deviation of the frequency drift, the SNR of the frequency drift, the RSRP, and the reference signal received quality RSRQ.

At 1006, the network entity may receive, from a second UE, second frequency drift information. The second frequency drift information may include a second frequency drift of the one or more TRSs relative to the reference TRS on the second UE. For example, referring to FIG. 6, the network entity (base station 604) may receive, at 644, from a second UE (additional UE(s) 606), second frequency drift information. The second frequency drift information may include a second frequency drift of the one or more TR Ss relative to the reference TRS on the second UE (additional UE(s) 606).

At 1008, the network entity may determine the CSI indication based on the frequency drift information received at 1004 (i.e., the first frequency drift information) and the second frequency drift information. For example, referring to FIG. 6, the network entity (base station 604) may determine, at 626, the CSI indication based on the frequency drift information received at 612 (i.e., the first frequency drift information) and the second frequency drift information (which was received from additional UE(s) 606 at 646).

At 1010, the network entity may transmit the CSI indication to the UE. The CSI indication may indicate for the UE to transmit the CSI report for one of: the CJT with the multiple TRPs, the NCJT with the multiple TRPs, or the transmission with the single TRP of the multiple TRPs. The CSI report received from the UE may be based on the CSI indication. For example, referring to FIG. 6, the network entity (base station 604) may transmit, at 614, the CSI indication to the UE 602. The CSI indication may indicate for the UE 602 to transmit the CSI report (at 618) for one of: the CJT with the multiple TRPs (e.g., TRP1 . . . TRPn of base station 604), the NCJT with the multiple TRPs (e.g., TRP1 . . . TRPn of base station 604), or the transmission with the single TRP of the multiple TRPs (e.g., TRP1 . . . TRPn of base station 604). The CSI report received from the UE 602 (at 618) may be based on the CSI indication.

In some aspects, the CSI report may be an aperiodic CSI report. For example, referring to FIG. 6, when the base station 604 receives, at 618, the CSI report, the CSI report may be an aperiodic CSI report.

In some aspects, the aperiodic CSI report may be triggered by a bit field in DCI. For example, referring to FIG. 6, the aperiodic CSI report (which the base station 604 receives at 618) may be triggered by a bit field in DCI.

In some aspects, the aperiodic CSI report may include a CJT CSI report and an N CJT CSI report. The CJT CSI report may be triggered by a first CSI state trigger, and the NCJT CSI report may be triggered by a second CSI state trigger different from the first CSI state trigger. For example, referring to FIG. 6, the aperiodic CSI report (which the base station 604 receives at 618) may include a CJT CSI report and an NCJT CSI report. The CJT CSI report may be triggered by a first CSI state trigger, and the NCJT CSI report may be triggered by a second CSI state trigger different from the first CSI state trigger.

In some aspects, the CSI report may be a periodic CSI report or a semi-persistent CSI report. The CSI indication may be transmitted via a MAC-CE. For example, referring to FIG. 6, when the base station 604 receives, at 618, the CSI report, the CSI report may be a periodic CSI report or a semi-persistent CSI report. The CSI indication (at 614) may be received via a MAC-CE.

In some aspects, the semi-persistent CSI report may include a CJT CSI report and an NCJT CSI report. The CJT CSI report may be triggered by a first CSI state trigger, and the NCJT CSI report may be triggered by a second CSI state trigger different from the first CSI state trigger. For example, referring to FIG. 6, the semi-persistent CSI report (which the base station 604 receives at 618) may include a CJT CSI report and an NCJT CSI report. The CJT CSI report may be triggered by a first CSI state trigger, and the NCJT CSI report may be triggered by a second CSI state trigger different from the first CSI state trigger.

At 1012, the network entity may receive, based on the frequency drift information, a CSI report from the UE. The CSI report may be for one of: CJT with the multiple TRPs, NCJT with the multiple TRPs, or a transmission with a single TRP of the multiple TRPs. For example, referring to FIG. 6, the network entity (base station 604) may receive, at 618, based on the frequency drift information, a CSI report to the UE 602. The CSI report may be for one of: CJT with the multiple TRPs (e.g., TRP1 . . . TRPn of base station 604), NCJT with the multiple TRPs (e.g., TRP1 . . . TRPn of base station 604), or a transmission with a single TRP of the multiple TRPs (e.g., TRP1 . . . TRPn of base station 604).

At 1014, the network entity may apply a frequency correction on the multiple TRPs based on the frequency drift information. For example, referring to FIG. 6, the network entity (base station 604) may apply, at 620, a frequency correction on the multiple TRPs based on the frequency drift information (which the base statin 604 received at 612).

At 1016, the network entity may receive at least one of a CSI reference time associated with the CSI report and a PMI from the UE. The PMI may be based on the frequency drift information. For example, referring to FIG. 6, the network entity (base station 604) may receive, at 622, at least one of a CSI reference time associated with the CSI report and a PMI from the UE 602. The PMI may be based on the frequency drift information.

At 1018, the network entity may receive a preference indication from the UE. The preference indication may indicate a CJT precoding, an NCJT precoding, or a single TRP precoding. For example, referring to FIG. 6, the network entity (base statin 604) may receive, at 624, a preference indication from the UE 602. The preference indication may indicate a CJT precoding, an NCJT precoding, or a single TRP precoding.

In some aspects, each TRS of the one or more TR Ss may respectively correspond to a single TRP of the multiple TRPs. For example, referring to FIG. 6, each TRS of the one or more TRSs (which the base station 604 transmits at 608) may respectively correspond to a single TRP of the multiple TRPs (TRP1 . . . TRPn of the base station 604).

In some aspects, one TRS of the multiple TRSs may correspond to a group of synchronized TRPs of the multiple TRPs. For example, referring to FIG. 6, one TRS of the one or more TRSs (which the base station 604 transmits at 608) may correspond to a group of synchronized TRP of the multiple TRPs (TRP1 . . . TRPn of the base station 604).

At 1020, the network entity may communicate with the UE based on the frequency drift information. For example, referring to FIG. 6, the network entity (base station 604) may communicate, at 628, with the UE 602 based on the frequency drift information (which the base station 604 received at 612).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IM U), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

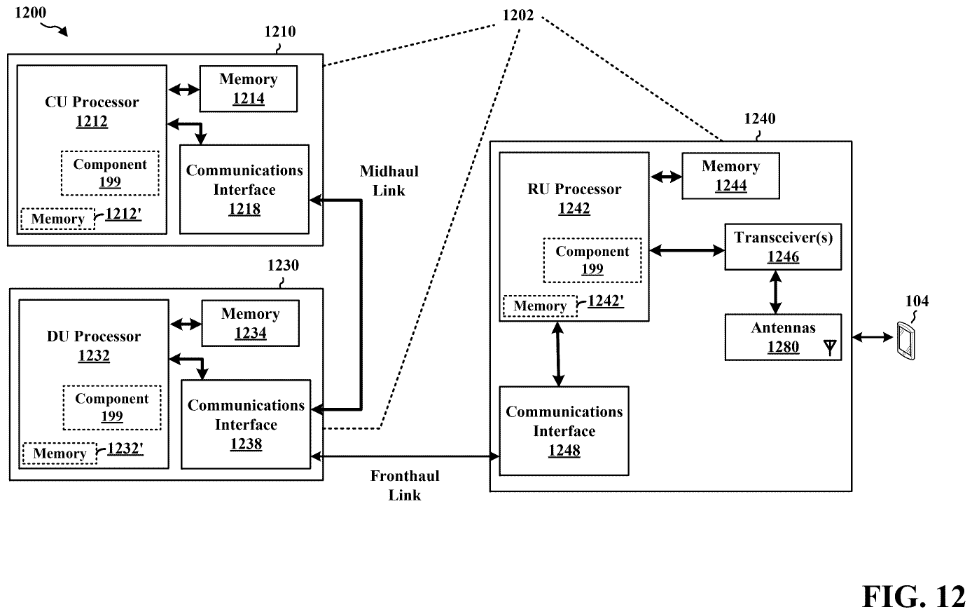

As discussed supra, the component 198 may be configured to receive, from a network entity, one or more TRSs for multiple TRPs of the network entity; measure frequency drift information including a frequency drift of the one or more TRSs relative to a reference TRS at the UE; transmit, to the network entity, the frequency drift information; and communicate, based on the frequency drift information, with the network entity. The component 198 may be further configured to perform any of the aspects described in connection with the flowcharts in FIG. 7 and FIG. 8, and/or performed by the UE 602 in FIG. 6. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving, from a network entity, one or more TRSs for multiple TRPs of the network entity, means for measuring frequency drift information including a frequency drift of the one or more TR Ss relative to a reference TRS at the UE, means for transmitting, to the network entity, the frequency drift information, and means for communicating, based on the frequency drift information, with the network entity. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means. FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a UE, one or more TRSs for multiple TRPs of the network entity; receive, from the UE, frequency drift information including a frequency drift of the one or more TRSs relative to a reference TRS at the UE; and communicate, based on the frequency drift information, with the UE. The component 199 may be further configured to perform any of the aspects described in connection with the flowcharts in FIG. 9 and FIG. 10, and/or performed by the base station 604 in FIG. 6. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting, to a UE, one or more TRSs for multiple TRPs of the network entity, means for receiving, from the UE, frequency drift information including a frequency drift of the one or more TR Ss relative to a reference TRS at the UE, and means for communicating, based on the frequency drift information, with the UE. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, one or more TRSs for multiple TRPs of the network entity; measuring frequency drift information including a frequency drift of the one or more TRSs relative to a reference TRS at the UE; transmitting, to the network entity, the frequency drift information; and communicating, based on the frequency drift information, with the network entity. The method enables a UE or a base station to monitor and compensate for the frequency drift of multiple TRPs of the base station of base stations. The frequency drift information further allows the UE or the base station to select a transmission mode for improved performance, and to reuse transmission parameters, such as the precoder, computed at an earlier time for the current communication. Thus, the method improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving one or more TRSs for multiple TRPs of the network entity from the network entity; measuring frequency drift information including a frequency drift of the one or more TRSs relative to a reference TRS at the UE; transmitting the frequency drift information to the network entity; and communicating, based on the frequency drift information, with the network entity.

Aspect 2 is the method of aspect 1, where the frequency drift information may further include one or more of: the standard deviation of the frequency drift, the SNR of the frequency drift, the RSRP, and the RSRQ.

Aspect 3 is the method of any of aspects 1 to 2, where the method may further include: transmitting, to the network entity, based on the frequency drift information, a CSI report for one of: CJT with the multiple TRPs, NCJT with the multiple TRPs, or a transmission with a single TRP of the multiple TRPs.

Aspect 4 is the method of aspect 3, where the method may further include applying, based on the frequency drift information, a frequency compensation corresponding to the multiple TRPs to compensate for the frequency drift. The CSI report may be based on the frequency compensation.

Aspect 5 is the method of any of aspects 1 to 4, where the method may further include transmitting at least one of a CSI reference time associated with the CSI report and a PMI to the network entity. The PMI may be based on the frequency drift information.

Aspect 6 is the method of any of aspects 1 to 3, where the method may further include transmitting a preference indication indicating a CJT precoding, an NCJT precoding, or a single TRP precoding to the network entity.

Aspect 7 is the method of any of aspects 1 to 3, where the method may further include receiving, from the network entity, a CSI indication indicating for the UE to transmit the CSI report for one of: the CJT with the multiple TRPs, the NCJT with the multiple TRPs, or the transmission with the single TRP of the multiple TRPs. And transmitting the CSI report may include transmitting the CSI report according to the CSI indication.

Aspect 8 is the method of aspect 7, where the CSI report may be an aperiodic CSI report.

Aspect 9 is the method of aspect 8, where the aperiodic CSI report may be triggered by a bit field in DCI.

Aspect 10 is the method of aspect 8, where the aperiodic CSI report may include a CJT CSI report and an NCJT CSI report. The CJT CSI report may be triggered by a first CSI state trigger, and the NCJT CSI report may be triggered by a second CSI state trigger different from the first CSI state trigger.

Aspect 11 is the method of aspect 7, where the CSI report may be a periodic CSI report or a semi-persistent CSI report, and the CSI indication may be received via a MAC-CE.

Aspect 12 is the method of aspect 11, where the semi-persistent CSI report may include a CJT CSI report and an NCJT CSI report. The CJT CSI report may be triggered by a first CSI state trigger, and the NCJT CSI report may be triggered by a second CSI state trigger different from the first CSI state trigger.

Aspect 13 is the method of any of aspects 1 to 12, where the one or more TRSs may respectively correspond to the multiple TRPs, or one TRS of the multiple TRSs may correspond to a group of synchronized TRPs of the multiple TRPs.

Aspect 14 is an apparatus for wireless communication at a UE, including: a memory; and at least one processor coupled to the memory and, based at least in part on information stored in the memory, the at least one processor is configured to perform the method of any of aspects 1-13.

Aspect 15 is the apparatus of aspect 14, further including at least one of a transceiver or an antenna coupled to the at least one processor and configured to receive the one or more TRSs for multiple TRPs and to transmit the frequency drift information.

Aspect 16 is an apparatus for wireless communication including means for implementing the method of any of aspects 1-13.

Aspect 17 is a computer-readable medium (e.g., a non-transitory computer-readable medium) storing computer executable code, where the code when executed by a processor causes the processor to implement the method of any of aspects 1-13.

Aspect 18 is a method of wireless communication at a network entity. The method may include transmitting one or more TRSs for multiple TRPs of the network entity to a UE; receiving, from the UE, frequency drift information including a frequency drift of the one or more TRSs relative to a reference TRS at the UE; and communicating, based on the frequency drift information, with the UE.

Aspect 19 is the method of aspect 18, where the frequency drift information may further include one or more of: a standard deviation of the frequency drift, the SNR of the frequency drift, the RSRP, and the RSRQ.

Aspect 20 is the method of any of aspects 18 to 19, where the method may further include receiving, from the UE, based on the frequency drift information, a CSI report for one of: CJT with the multiple TRPs, NCJT with the multiple TRPs, or a transmission with a single TRP of the multiple TRPs.

Aspect 21 is the method of aspect 20, where the method may further include applying a frequency correction on the multiple TRPs based on the frequency drift information.

Aspect 22 is the method of any of aspects 18 to 20, where the method may further include receiving, from the UE, at least one of: a CSI reference time associated with the CSI report, and a PMI from the UE. The PMI may be based on the frequency drift information.

Aspect 23 is the method of any of aspects 18 to 20, where the method may further include receiving a preference indication indicating a CJT precoding, an NCJT precoding, or a single TRP precoding from the UE.

Aspect 24 is the method of any of aspects 18 to 20, where the method may further include transmitting, to the UE, a CSI indication indicating for the UE to transmit the CSI report for one of: the CJT with the multiple TRPs, the NCJT with the multiple TRPs, or the transmission with the single TRP of the multiple TRPs. The CSI report received from the UE may be based on the CSI indication.

Aspect 25 is the method of aspect 24, where the UE may be a first UE, the frequency drift information may be the first frequency drift information, and the method may further include: receiving, from a second UE, second frequency drift information including a second frequency drift of the one or more TR Ss relative to the reference TRS on the second UE; and determining the CSI indication based on the first frequency drift information and the second frequency drift information.

Aspect 26 is the method of aspect 24, where the CSI report may be an aperiodic CSI report.

Aspect 27 is the method of aspect 26, where the aperiodic CSI report may be triggered by a bit field in DCI.

Aspect 28 is the method of aspect 26, where the aperiodic CSI report may include a CJT CSI report and an NCJT CSI report. The CJT CSI report may be triggered by a first CSI state trigger, and the NCJT CSI report may be triggered by a second CSI state trigger different from the first CSI state trigger.

Aspect 29 is the method of aspect 24, where the CSI report may be a periodic CSI report or a semi-persistent CSI report, and the CSI indication may be transmitted via a MAC-CE.

Aspect 30 is the method of aspect 29, where the semi-persistent CSI report includes a CJT CSI report and an NCJT CSI report. The CJT CSI report may be triggered by a first CSI state trigger, and the NCJT CSI report may be triggered by a second CSI state trigger different from the first CSI state trigger.

Aspect 31 is the method of any of aspects 18 to 29, where the one or more TR Ss may respectively correspond to the multiple TRPs, or one TRS of the multiple TRSs may correspond to a group of synchronized TRPs of the multiple TRPs.

Aspect 32 is an apparatus for wireless communication at a network entity, including: a memory; and at least one processor coupled to the memory and, based at least in part on information stored in the memory, the at least one processor is configured to perform the method of any of aspects 18-31.

Aspect 33 is the apparatus of aspect 32, further including at least one of a transceiver or an antenna coupled to the at least one processor and configured to transmit the one or more TRSs for multiple TRPs and to receive the frequency drift information.

Aspect 34 is an apparatus for wireless communication including means for implementing the method of any of aspects 18-31.

Aspect 35 is a computer-readable medium (e.g., a non-transitory computer-readable medium) storing computer executable code, where the code when executed by a processor causes the processor to implement the method of any of aspects 18-31.

1. An apparatus for wireless communication at a user equipment (UE), comprising:
memory; and
at least one processor coupled to the memory and, based at least in part on information stored in the memory, the at least one processor is configured to:
receive, from a network entity, one or more Tracking Reference Signals (TRSs) for multiple Transmit Reception Points (TRPs) of the network entity;
measure frequency drift information including a frequency drift of the one or more TRSs relative to a reference TRS at the UE;
transmit, to the network entity, the frequency drift information; and
communicate, based on the frequency drift information, with the network entity.

2. The apparatus of claim 1, further comprising a transceiver coupled to the at least one processor, wherein, to receive the one or more TRSs, the at least one processor is configured to receive the one or more TRSs via the transceiver, and wherein the frequency drift information further includes one or more of:
a standard deviation of the frequency drift;
a signal-noise-ratio (SNR) of the frequency drift;
a reference signal received power (RSRP); and
a reference signal received quality (RSRQ).

3. The apparatus of claim 1, wherein the at least one processor is further configured to:
transmit, to the network entity, based on the frequency drift information, a channel state information (CSI) report for one of:
coherent joint transmission (CJT) with the multiple TRPs,
non-coherent joint transmission (NCJT) with the multiple TRPs, or
a transmission with a single TRP of the multiple TRPs.

4. The apparatus of claim 3, wherein the at least one processor is further configured to:
apply, based on the frequency drift information, a frequency compensation corresponding to the multiple TRPs to compensate for the frequency drift, wherein the CSI report is based on the frequency compensation.

5. The apparatus of claim 3, wherein the at least one processor is further configured to:
transmit at least one of:
a CSI reference time associated with the CSI report; and
a precoding matrix indicator (PMI), wherein the PMI is based on the frequency drift information.

6. The apparatus of claim 3, wherein the at least one processor is further configured to:
transmit, to the network entity, a preference indication indicating a CJT precoding, an NCJT precoding, or a single TRP precoding.

7. The apparatus of claim 3, wherein the at least one processor is further configured to:
receive, from the network entity, a CSI indication indicating for the UE to transmit the CSI report for one of:
the CJT with the multiple TRPs,
the NCJT with the multiple TRPs, or
the transmission with the single TRP of the multiple TRPs, and
wherein, to transmit the CSI report, the at least one processor is configured to:
transmit the CSI report according to the CSI indication.

8. The apparatus of claim 7, wherein the CSI report is an aperiodic CSI report.

9. The apparatus of claim 8, wherein the aperiodic CSI report is triggered by a bit field in Downlink Control Information (DCI).

10. The apparatus of claim 8, wherein the aperiodic CSI report includes a CJT CSI report and an NCJT CSI report, the CJT CSI report is triggered by a first CSI state trigger, and the NCJT CSI report is triggered by a second CSI state trigger different from the first CSI state trigger.

11. The apparatus of claim 7, wherein the CSI report is a periodic CSI report or a semi-persistent CSI report, and the CSI indication is received via a medium access control-control element (MAC-CE).

12. The apparatus of claim 11, wherein the semi-persistent CSI report includes a CJT CSI report and an NCJT CSI report, wherein the CJT CSI report is triggered by a first CSI state trigger, and the NCJT CSI report is triggered by a second CSI state trigger different from the first CSI state trigger.

13. The apparatus of claim 1, wherein:
the one or more TRSs respectively correspond to the multiple TRPs, or one TRS of the multiple TRSs corresponds to a group of synchronized TRPs of the multiple TRPs.

14. An apparatus for wireless communication at a network entity, comprising:
memory; and
at least one processor coupled to the memory and, based at least in part on information stored in the memory, the at least one processor is configured to:
transmit, to a user equipment (UE), one or more Tracking Reference Signals (TRSs) for multiple Transmit Reception Points (TRPs) of the network entity;
receive, from the UE, frequency drift information including a frequency drift of the one or more TRSs relative to a reference TRS at the UE; and
communicate, based on the frequency drift information, with the UE.

15. The apparatus of claim 14, further comprising a transceiver coupled to the at least one processor, wherein, to transmit the one or more TRSs, the at least one processor is configured to transmit the one or more TRSs via the transceiver, and wherein the frequency drift information further includes one or more of:
a standard deviation of the frequency drift;
a signal-noise-ratio (SNR) of the frequency drift;
a reference signal received power (RSRP); and
a reference signal received quality (RSRQ).

16. The apparatus of claim 14, wherein the at least one processor is further configured to:
receive, from the UE, based on the frequency drift information, a channel state information (CSI) report for one of:
coherent joint transmission (CJT) with the multiple TRPs,
non-coherent joint transmission (NCJT) with the multiple TRPs, or
a transmission with a single TRP of the multiple TRPs.

17. The apparatus of claim 16, wherein the at least one processor is further configured to:
apply a frequency correction on the multiple TRPs based on the frequency drift information.

18. The apparatus of claim 16, wherein the at least one processor is further configured to:
receive, from the UE, at least one of:
a CSI reference time associated with the CSI report, and
a precoding matrix indicator (PMI), wherein the PMI is based on the frequency drift information.

19. (canceled)

20. (canceled)

21. (canceled)

22. (canceled)

23. (canceled)

24. (canceled)

25. (canceled)

26. (canceled)

27. (canceled)

28. A method of wireless communication at a user equipment (UE), comprising:
receiving, from a network entity, one or more Tracking Reference Signals (TRSs) for multiple Transmit Reception Points (TRPs) of the network entity;
measuring frequency drift information including a frequency drift of the one or more TRSs relative to a reference TRS at the UE;
transmitting, to the network entity, the frequency drift information; and
communicating, based on the frequency drift information, with the network entity.

29. The method of claim 28, wherein the frequency drift information further includes one or more of:
a standard deviation of the frequency drift;
a signal-noise-ratio (SNR) of the frequency drift;
a reference signal received power (RSRP); and
a reference signal received quality (RSRQ).

30. (canceled)
